(19) United States
(12) Patent Application Publication
(10) Pub. No.: US 2025/0058614 A1
(43) Pub. Date: Feb. 20, 2025

(54) FOLDING TRUCK BED COVERS WITH SELF-LOCKING COMPOUND HINGES

(71) Applicant: Diamondback Automotive Accessories, Inc., Philipsburg, PA (US)

(72) Inventors: Cody Thompson Byron, Philipsburg, PA (US); Daniel J. Gongloff, Ashville, PA (US); Brandon Jacob Moist, Hummelstown, PA (US); Travis Paul Dodson, Hollidaysburg, PA (US)

(21) Appl. No.: 18/807,668

(22) Filed: Aug. 16, 2024

Related U.S. Application Data
(60) Provisional application No. 63/533,314, filed on Aug. 17, 2023.

(51) Int. Cl. B60J 7/14; B60J 7/00

(52) U.S. Cl. CPC B60J 7/141; B60J 7/0084

(57) ABSTRACT

Folding truck bed covers with self-locking compound hinges are disclosed. The covers may include rigid front, middle and rear panels. To open the cover, the rear panel is folded over the middle panel, then the folded middle and rear panels are folded over the front panel. A front edge of the middle panel may be pivotally mounted to a rear edge of the front panel by a compound hinge assembly including at least one compound or double hinge that permits the folded rear and middle panels to fold onto the top outer surface of the front panel. The compound hinge assembly may be used with a catch bar and catch bracket that provide a self-locking feature that prevents unwanted opening or break-ins of the cover when the cover is in its fully closed position.

### CROSS-REFERENCE TO RELATED APPLICATION

This application claims the benefit of U.S. Provisional Patent Application No. 63/533,314 filed Aug. 17, 2023, which is incorporated herein by reference.

### FIELD OF THE INVENTION

The present invention relates to folding truck bed covers with self-locking compound hinges.

### BACKGROUND INFORMATION

Various types of truck bed covers, also known as tonneau covers, are known. A need exists for covers that are easy to install and use, and are secure against unwanted opening or break-ins.

### SUMMARY OF THE INVENTION

The present invention provides folding truck bed covers with self-locking compound hinges. The covers may include rigid front, middle and rear panels. To open the cover, the rear panel is folded over the middle panel, then the folded middle and rear panels are folded over the front panel. A front edge of the middle panel may be pivotally mounted to a rear edge of the front panel by a compound hinge assembly including at least one compound or double hinge that permits the folded rear and middle panels to fold onto the top outer surface of the front panel. The compound hinge assembly may be used with a catch bar and catch bracket that provide a self-locking feature that prevents unwanted opening or break-ins of the cover when the cover is in its fully closed position.

An aspect of the present invention is to provide a multiple-panel folding truck bed cover comprising a front panel structured and arranged for mounting on truck sidewall rails comprising a front panel rear edge, a middle panel structured and arranged for mounting on the truck sidewall rails comprising a middle panel front edge, at least one compound hinge attached to the front panel adjacent the front panel rear edge and attached to the middle panel adjacent the middle panel front edge, and a catch bar and catch bracket assembly structured and arranged to resist relative movement between the front panel rear edge and the middle panel front edge when the front panel and the middle panel are in closed positions on the truck sidewall rails. The catch bar and catch bracket assembly comprises a catch bar attached adjacent to one of the front panel rear edge or the middle panel front edge, and at least one catch bracket attached adjacent to the other one of the front panel rear edge or the middle panel front edge structured and arranged to engage the catch bar to thereby resist the relative movement between the front panel rear edge and the middle panel front edge when the front panel and the middle panel are in the closed positions.

Another aspect of the present invention is to provide a multiple-panel folding truck bed cover comprising a front panel structured and arranged for mounting on truck sidewall rails comprising a front panel rear edge, a middle panel structured and arranged for mounting on the truck sidewall rails comprising a middle panel front edge, and at least two compound hinges attached to the front panel adjacent the front panel rear edge and attached to the middle panel adjacent the middle panel front edge spaced apart from each other transversely along a seam between the front panel rear edge and the middle panel front edge.

These and other aspects of the present invention will be more apparent from the following description.

### BRIEF DESCRIPTION OF THE DRAWINGS

FIG. 1 is a top rear isometric view of a multiple-panel folding truck bed cover mounted on a truck bed.

FIG. 2 is a top side perspective view of the multiple-panel folding truck bed cover of FIG. 1.

FIG. 3 is a top rear isometric view of a multiple-panel folding truck bed cover with rear and middle panels folded onto a front panel in an open position on a truck bed.

FIG. 4 is a top rear isometric view of a multiple-panel folding truck bed cover in a partially open position on a truck bed.

FIG. 5 is a top rear isometric view of a multiple-panel folding truck bed cover.

FIG. 6 is a bottom rear isometric view of the multiple-panel folding truck bed cover of FIG. 5.

FIG. 7 is a top front isometric view of a portion of a multiple-panel folding truck bed cover including a compound hinge.

FIG. 8 is a top side perspective view of the front panel of a multiple-panel folding truck bed cover including front tie down clips.

FIG. 9 is a top side perspective view of a multiple-panel folding truck bed cover of the present invention including side tie down clips.

FIG. 10 is a side perspective view of a compound hinge attached at one end to a top surface of a front panel and attached at an opposite end to a top surface of a middle panel of a truck bed cover.

FIG. 11 is a side perspective view of the compound hinge of FIG. 10 illustrating the ability of the compound hinge to allow relative sliding movement between the middle panel and front panel during folding of the panels.

FIG. 12 is a partially schematic side view of a catch bar and catch bracket assembly for securing the middle panel in relation to the front panel illustrating rotation of the catch bracket toward engagement with the catch bar when the truck bed cover is in its closed position.

FIG. 13 is a partially schematic side view of a catch bar and catch bracket assembly similar to FIG. 12 with the catch bracket rotated into position under the catch bar.

FIG. 14 is a partially schematic side view of another catch bar and catch bracket assembly for securing the middle panel in relation to the front panel.

FIG. 15 is a top side perspective view of a middle panel in an open position with catch brackets secured to the underside of the middle panel.

FIG. 16 is a bottom side perspective view of the underside of the truck bed cover illustrating the catch bracket of the middle panel engaging the catch bar of the front panel.

FIG. 17 is a top side perspective view illustrating the use of a pry bar to lift a middle panel in relation to a front panel when compound hinges are used without a catch bar and catch bracket.

FIG. 18 is a top side perspective view illustrating a pry bar that is unable to significantly open the middle panel in relation to the front panel when a catch bar and catch bracket are provided in combination with the compound hinges.

### DETAILED DESCRIPTION

The present invention provides folding truck bed covers with self-locking compound hinges. The covers may include rigid front, middle and rear or tail panels. The front, middle and rear panels may be load-bearing panels capable of holding significant amounts of weight, e.g., for hauling various types of equipment and/or tools thereon. To open the cover, the rear panel is folded over the middle panel, then the folded middle and rear panels are folded over the front panel. A front edge of the middle panel may be pivotally mounted to a rear edge of the front panel by a compound hinge assembly. The compound hinge assembly includes at least one compound or double hinge that permits the folded rear and middle panels to fold onto the top outer surface of the front panel, with the bottom inner surface of the rear panel resting on the top outer surface of the front panel. In one embodiment, the compound hinge assembly includes two separate compound hinges spaced from each other transversely along a seam extending between the front edge of the middle panel and a rear edge of the front panel. A front edge of the rear panel may be pivotally mounted to a rear edge of the middle panel, for example, by at least one hinge. The rear panel may be pivoted from a flat closed position 180 degrees to an open position in which the top outer surface of the rigid rear panel contacts and rests on the top outer surface of the rigid middle panel. In the fully folded or open position, the top outer surfaces of the rigid middle and rear panels continue to contact each other, and the bottom inner surface of the rigid middle panel faces upward. The compound hinge assembly connecting the front and middle panels allows sufficient clearance space for the rear panel to be folded between the front panel and the middle panel when the cover is in its open position.

The multiple-panel folding truck bed cover also includes a self-locking feature that, in combination with the compound hinge assembly, prevents unwanted opening or break-ins of the cover when the cover is in its fully closed position. Self-locking may be achieved by the use of a catch bar and catch brackets that engage with each other when the middle panel is in its closed position nexted to the front panel.

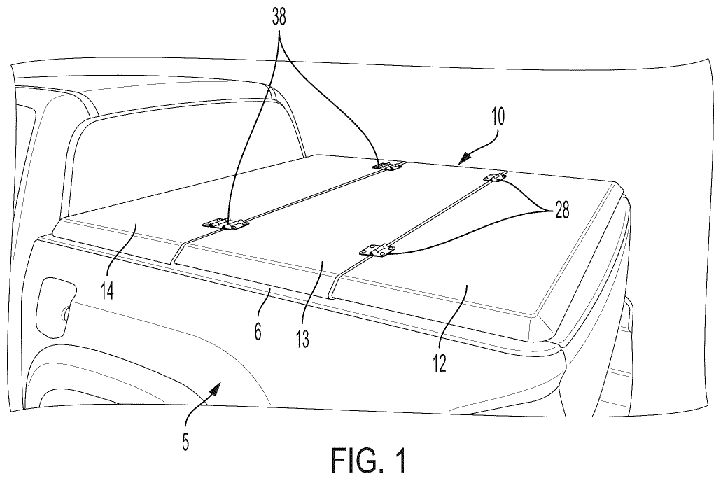

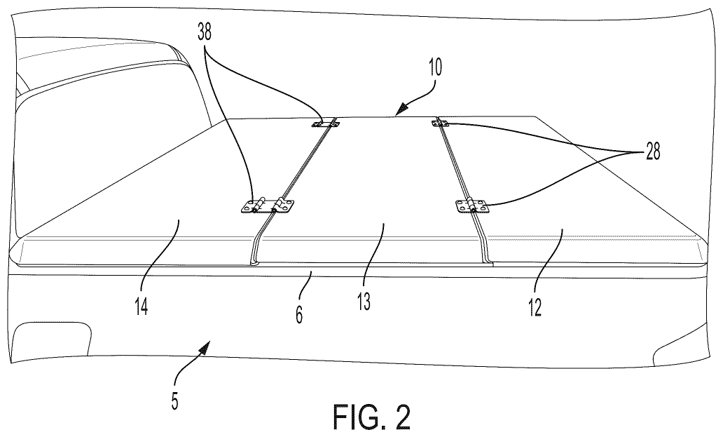

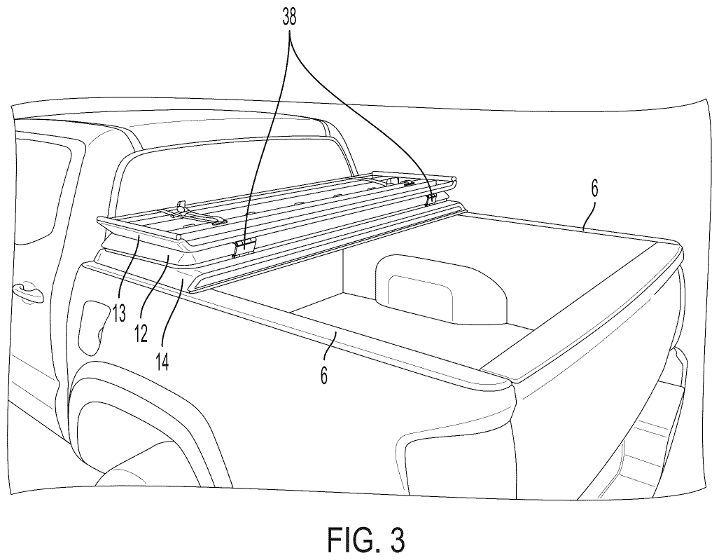

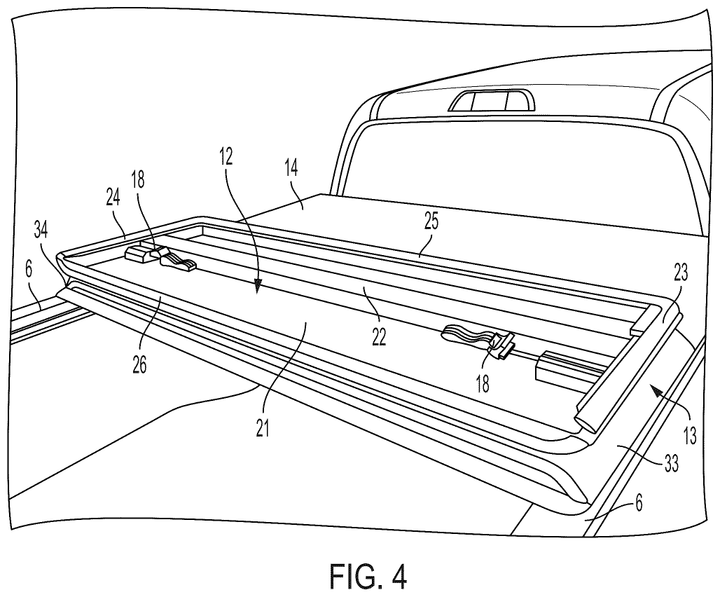

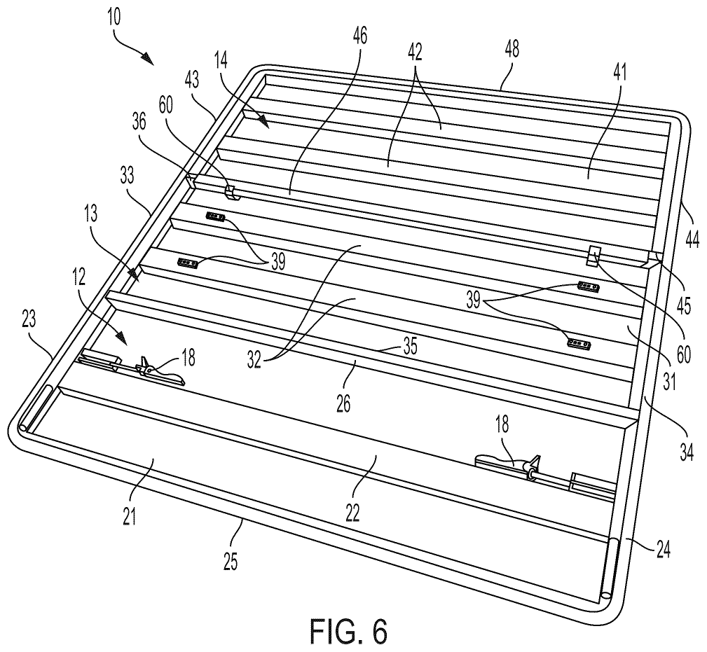

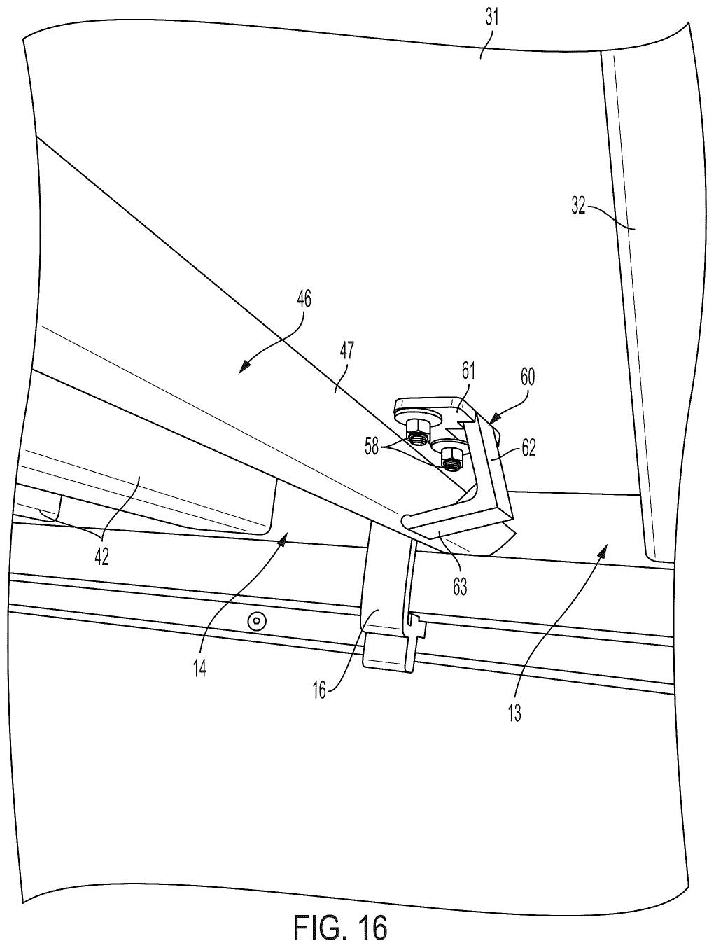

FIGS. 1-7 illustrate a multiple-panel folding truck bed cover 10 of the present invention attached to a truck bed 5 with sidewall rails 6. The multiple-panel folding truck bed cover 10 includes a rear panel 12, middle panel 13, and front panel 14. The rear, middle and front panels 12, 13, 14 may be rigid and load-bearing, for example, capable of holding at least 100 lbs, or at least 200 lbs, or at least 400 lbs or more. The rear panel 12 and middle panel 13 are pivotally connected together by rear hinges 28, and the middle panel 13 and front panel 14 are pivotally connected together by compound hinges 38. The multiple-panel folding truck bed cover 10 may be secured to the truck sidewall rails 6, for example, with clamps provided on the underside of the front panel 14 and clamps provided on the underside of the rear panel 12. FIGS. 4 and 6 show rear panel clamps 18 provided on opposite sides of the rear panel 12 to provide two securement locations for the rear panel 12 when in its closed position. The rear panel clamps 18 may be accessed when the tailgate is opened, but are not accessible when the tailgate is closed and locked. In addition, front panel clamps 16, such as the one shown in FIG. 16, may be provided on opposite sides of the front panel 14. As shown in FIG. 3, straps may be used to hold down and secure the middle panel 13 and underlying rear panel 12 in the open position. The tie-down straps may be secured to anchor plates or tie down clamps on the front panel 14, such as the front tie down clips 49 described below.

As shown in FIGS. 4-6, the rear panel 12 includes a top surface 20, bottom surface 21, right side edge 23, left side edge 24, rear edge 25, and front edge 26. As shown in FIGS. 4 and 6, a support stud 22 is secured to the bottom surface 21 of the rear panel 12.

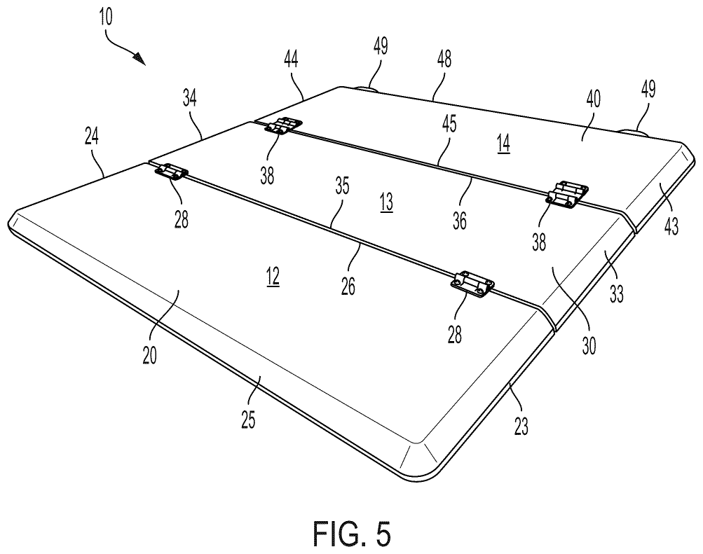

As shown in FIGS. 5 and 6, the middle panel 13 includes a top surface 30, bottom surface 31, right side edge 33, left side edge 34, rear edge 35, and front edge 36. As shown in FIG. 6, support studs 32 are attached to the bottom surface 31 of the middle panel 13.

As shown in FIGS. 5 and 6, the front panel 14 includes a top surface 40, bottom surface 41, right side edge 43, left side edge 44, rear edge 45, and front edge 48. Support studs 42 are attached to the bottom surface 41 of the front panel 14. Front tie down clips 49 may be provided on the front edge 48 for receiving the hold-down straps noted above.

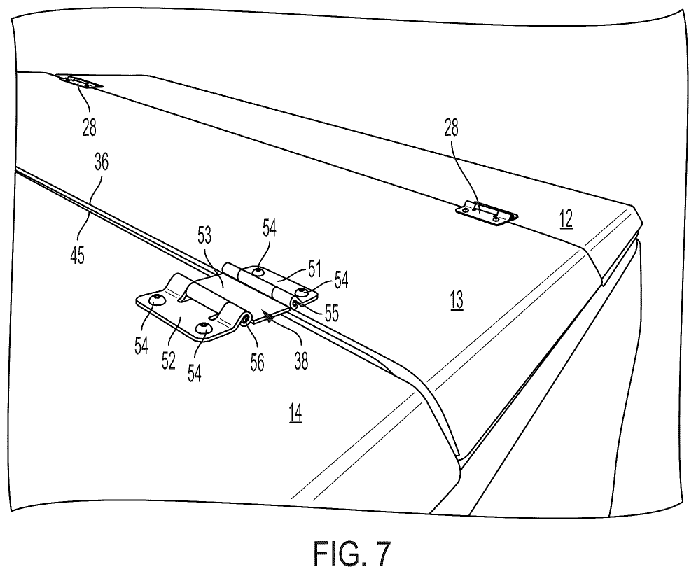

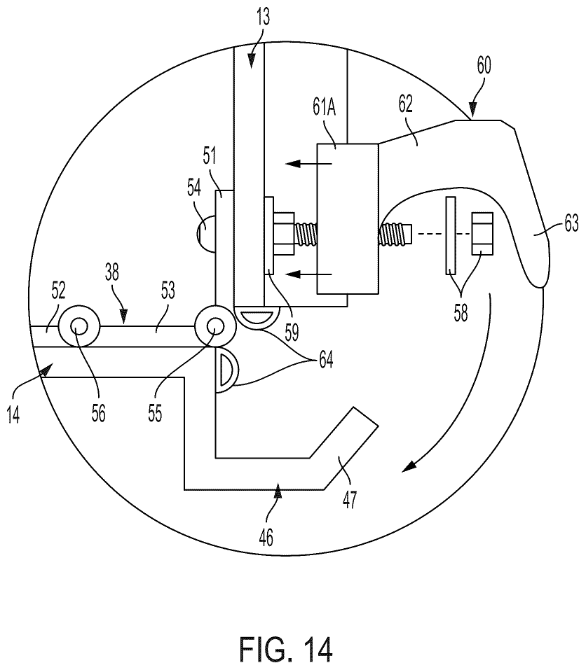

FIGS. 7 and 10-14 illustrate details of the compound hinges 38. The compound hinge 38 includes a rear bracket 51, front bracket 52, and spacer bracket 53. The rear bracket 51 is attached to the spacer bracket 53 by a rear pivot pin 55. The front bracket 52 is attached to the spacer bracket 53 by a front pivot pin 56. Mechanical fasteners 54 such as bolts, rivets or the like are used to fasten the rear bracket 51 to the middle panel 13. The catch bar 46 includes a catch lip 47. The catch lip 47 of the catch bar 46 forms a water-diverting trough or channel when the middle panel 13 is in its closed position.

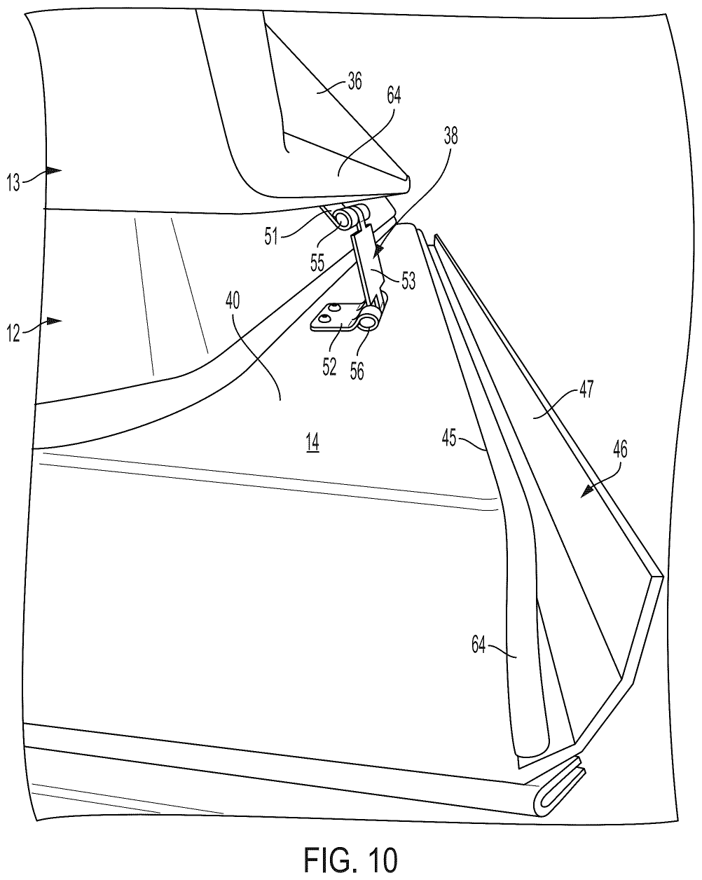

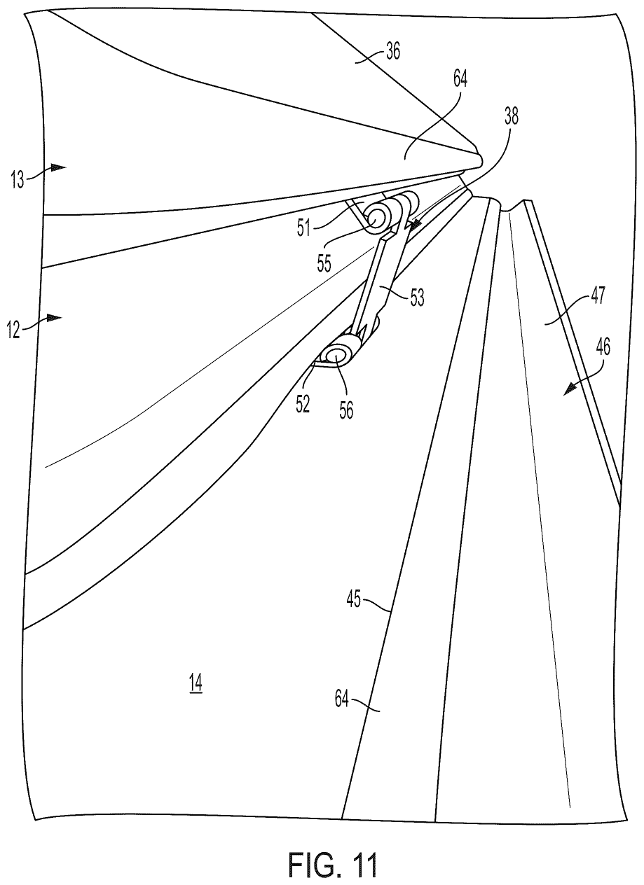

FIG. 10 is a side perspective view of a compound hinge attached at one end to a top surface of a front panel and attached at an opposite end to a top surface of a middle panel of a truck bed cover. FIG. 11 is a side perspective view of the compound hinge of FIG. 10 illustrating the ability of the compound hinge to allow relative sliding movement between the middle panel and front panel during folding of the panels. The compound hinges 38 thus provide tolerance or play between the relative positions of the front 14, middle 13, and rear 12 panels when the panels are folded.

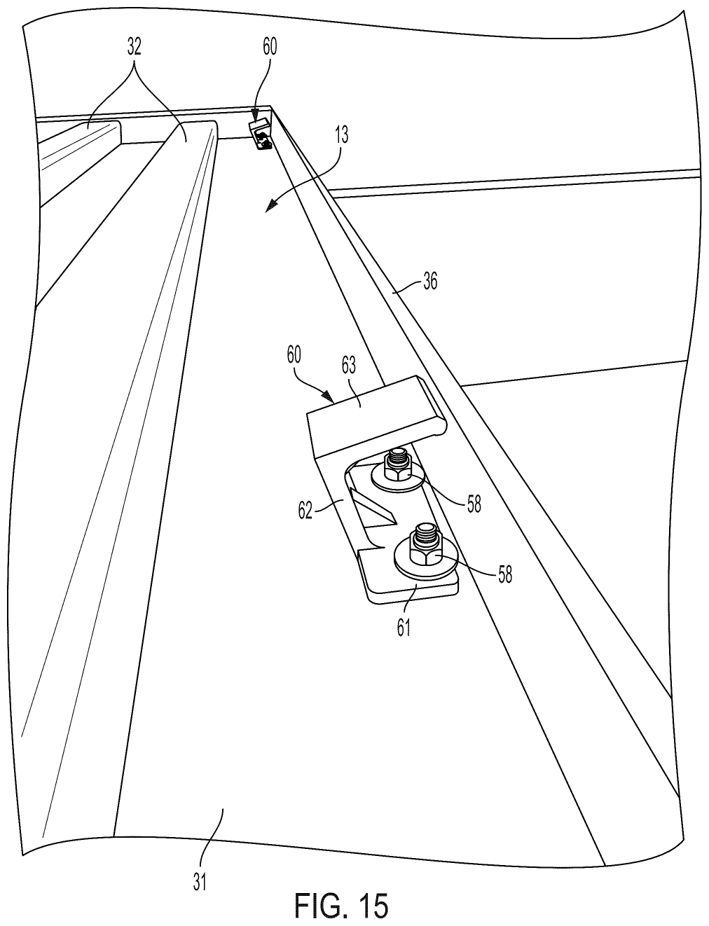

FIGS. 10-16 illustrate a catch bar 46 secured adjacent the rear edge 65 of the front panel 14. The catch bar 46 may be attached at the rear edge 45 of the front panel 14, and may be located below the seam between the front 14 and middle 13 panels when the middle panel 13 is in its closed position. The catch bar 46 may also serve as a rain gutter or water-diverting channel. Drain holes may be provided in the front edge 36 of the middle panel 13. When the middle panel 13 is in its closed position, the drain holes extending through the sheet material of the front edge 36 may be located above the rain gutter or channel provided as part of the catch bar 46 and catch lip 47 located below the rear edge 45 of the front panel 14 to thereby allow water and other liquids to drain through the holes into the rain gutter or channel. Any suitable number of drain holes may be provided, for example, one to six or more drain holes across the transverse width of the front edge 36 of the middle panel 13.

FIGS. 6 and 12-16 illustrate a catch bracket 60. The catch bracket 60 may include a base 61, arm 62 and latch tab 63. The latch tabs 63 of the catch bracket 60 rotate into latching positions underneath the securing catch bar 46 when the middle panel 13 is rotated from its open position to its closed position. Opposing gasket seals 64 may be used to seal the seam between the rear edge 45 of the front panel 14 and the front edge 36 of the middle panel 13.

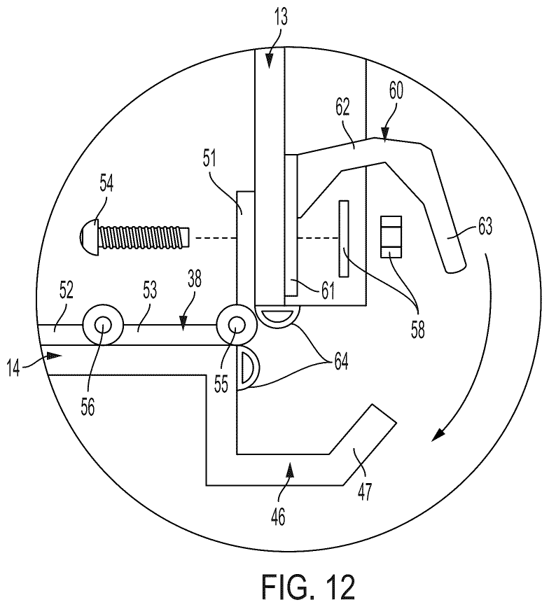

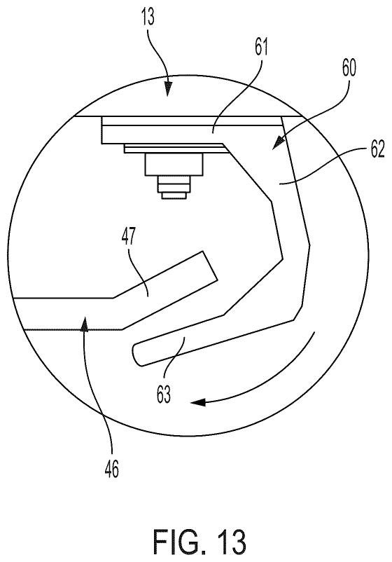

In the embodiment shown in FIG. 12, the base 61 comprises a flat plate attached to the bottom surface 31 of the middle panel 13 with the fasteners 54 and attachment nuts and washers 58. In the embodiment shown in FIG. 13, the catch base 61A is channeled with a generally U-shaped cross section that receives interior attachment nuts and washers 59 therein. The ends of the U-shaped arms of the channeled base 61A contact the bottom surface 31 of the middle panel 13. The fasteners 54 extend through the rear bracket 51 and middle panel 13 and are secured by the interior attachment nuts and washers 59, which are located in the channeled base 61A when assembled. The exposed attachment nuts and washers 58 are then used to secure the bracket 61A onto the middle panel 13.

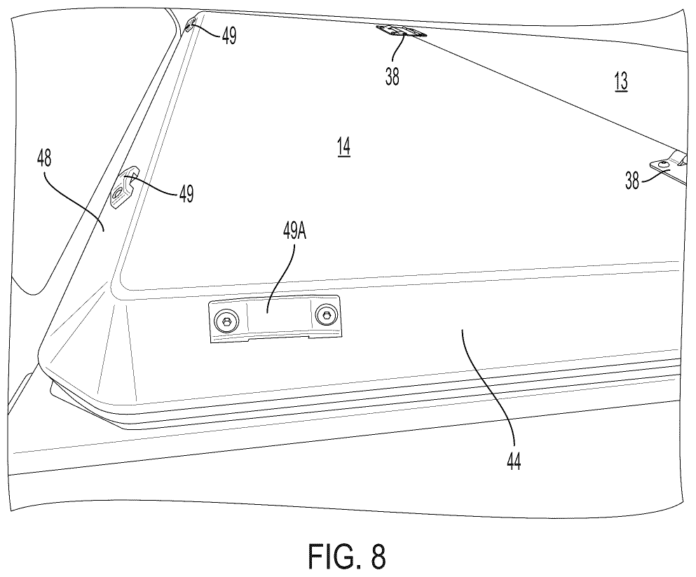

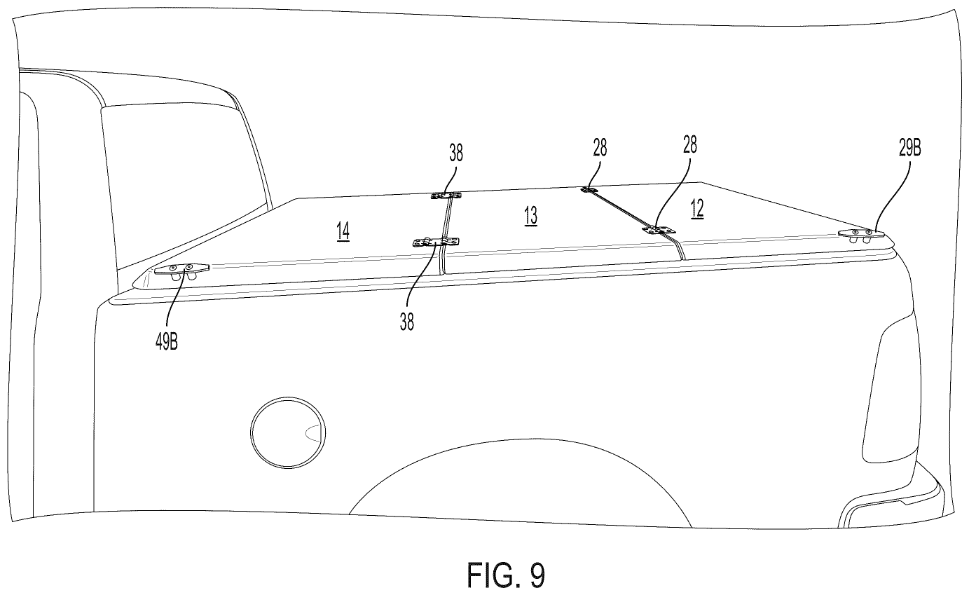

FIG. 8 illustrates the front panel 14 of a multiple-panel folding truck bed cover including front tie downs 49 attached adjacent the front edge 48 of the panel, and side tie downs 49A attached to the side edges 43 and 44 of the front panel 14. FIG. 9 illustrates side tie downs 29A and 29B attached to the rear panel 12 and front panel 14 of a multiple-panel folding truck bed cover.

As shown in FIG. 6, underside tie down clips 39 may be attached to the support stud(s) 32 of the middle panel 13, or may be attached at any desired locations on the undersides of the panels 12, 13 and 14. For example, tie-down clips, clamps or brackets may be fastened to hinges connecting the rear and middle panels. Such tie-down clamps may thus be integrated with the hinges. Although not shown, additional tie-down clamps may be secured to the compound hinges between the middle and front panels.

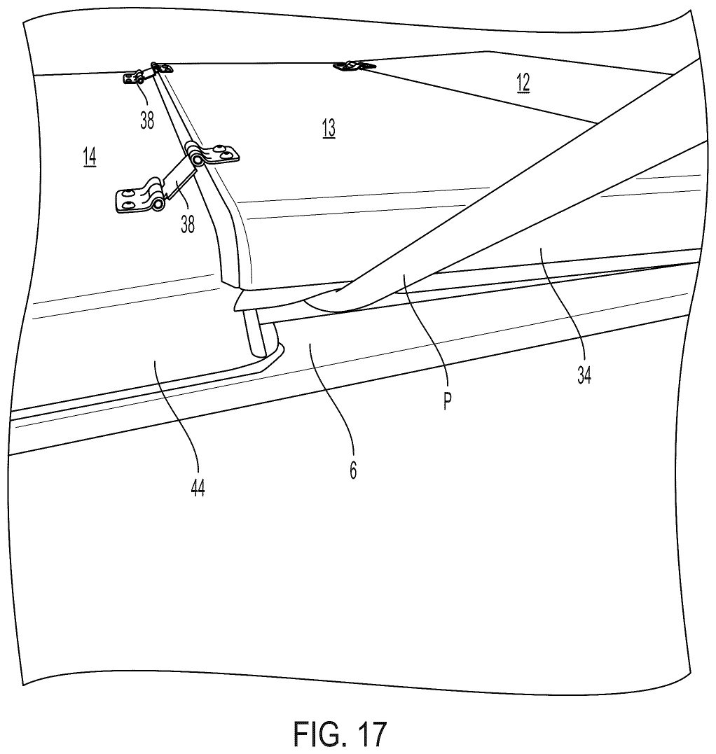

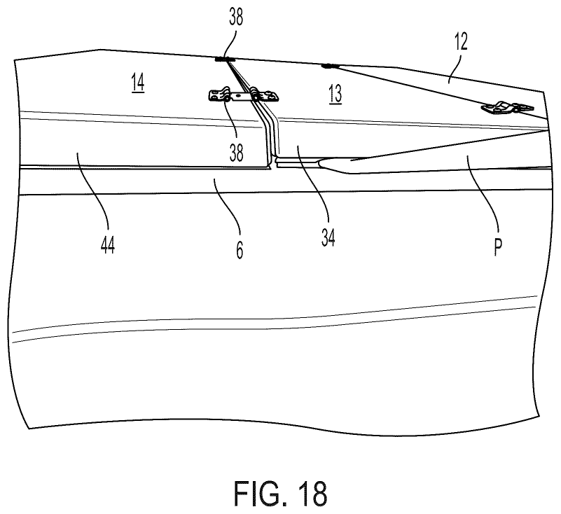

FIG. 17 illustrates a top side perspective view illustrating the use of a pry bar P to lift a middle panel in relation to a front panel when compound hinges are used without a catch bar and catch bracket. The pry bar P is being used in an attempt to break into the truck bed cover 10 without latch tabs of the present invention. FIG. 18 illustrates a top side perspective view illustrating a pry bar that is unable to significantly open the middle panel in relation to the front panel when a catch bar and catch bracket are provided in combination with the compound hinges. When equipped with the catch bar and catch brackets of the present invention, the middle panel 13 is substantially prevented from being opened at the front edge 36 of the panel adjacent the compound hinges 38. The catch bar 46 and catch brackets 60 thus provide anti-break-in security features in comparison with truck bed covers that do not include such a combination of a catch bar and brackets, and in comparison with conventional truck bed covers that may be more susceptible to damage and break-ins.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A multiple-panel folding truck bed cover comprising:
a front panel structured and arranged for mounting on truck sidewall rails comprising a front panel rear edge;
a middle panel structured and arranged for mounting on the truck sidewall rails comprising a middle panel front edge;
at least one compound hinge attached to the front panel adjacent the front panel rear edge and attached to the middle panel adjacent the middle panel front edge; and
a catch bar and catch bracket assembly structured and arranged to resist relative movement between the front panel rear edge and the middle panel front edge when the front panel and the middle panel are in closed positions on the truck sidewall rails, wherein the catch bar and catch bracket assembly comprises:
a catch bar attached adjacent to one of the front panel rear edge or the middle panel front edge; and
at least one catch bracket attached adjacent to the other one of the front panel rear edge or the middle panel front edge structured and arranged to engage the catch bar to thereby resist the relative movement between the front panel rear edge and the middle panel front edge when the front panel and the middle panel are in the closed positions.

2. The multiple-panel folding truck bed cover of claim 1, wherein the catch bar is attached to the front panel rear edge and the at least one catch bracket is attached adjacent to the middle panel front edge.

3. The multiple-panel folding truck bed cover of claim 2, wherein the catch bar comprises a catch lip engageable with the at least one catch bracket.

4. The multiple-panel folding truck bed cover of claim 3, wherein the catch lip forms a water diverting channel vertically below the front panel rear edge and middle panel front edge.

5. The multiple-panel folding truck bed cover of claim 4, wherein at least one of the front panel rear edge and the middle panel front edge comprise a gasket seal structured and arranged to resist water flow between the front panel rear edge and the middle panel front edge when the front panel and the middle panel are in the closed positions.

6. The multiple-panel folding truck bed cover of claim 1, wherein the at least one catch bracket comprises a base attached to an underside of the middle panel or the front panel.

7. The multiple-panel folding truck bed cover of claim 6, wherein the at least one catch bracket further comprises a latch tab extending from the base structured and arranged to engage the catch bar.

8. The multiple-panel folding truck bed cover of claim 6, wherein the catch bracket is attached to the underside of the middle panel.

9. The multiple-panel folding truck bed cover of claim 8, wherein the catch bracket is attached to the middle panel by at least one mechanical fastener.

10. The multiple-panel folding truck bed cover of claim 9, wherein the at least one mechanical fastener also attaches the compound hinge to the middle panel.

11. The multiple-panel folding truck bed cover of claim 10, comprising two of the compound hinges and two of the catch brackets, wherein a mechanical fastener attaches one of the compound hinges and one of the catch brackets to the middle panel, and another mechanical fastener attaches the other one of the compound hinges and the other one of the catch brackets to the middle panel.

12. The multiple-panel folding truck bed cover of claim 1, wherein the at least one compound hinge comprises:
a front bracket attached to the front panel;
a rear bracket attached to the middle panel; and
a spacer bracket pivotally connected to each of the front bracket and the rear bracket.

13. The multiple-panel folding truck bed cover of claim 12, wherein the front bracket is pivotally connected to the spacer bracket by a front pivot pin, and the rear bracket is pivotally connected to the spacer bracket by a rear pivot pin.

14. The multiple-panel folding truck bed cover of claim 12, wherein the front bracket is attached to a top surface of the front panel, and the rear bracket is attached to a top surface of the middle panel.

15. The multiple-panel folding truck bed cover of claim 14, wherein the spacer bracket comprises an underside that contacts a top surface of either the front panel or a top surface of the middle panel when the front panel and the middle panel are in the closed positions, but does not contact the top surfaces of the front and middle panels when the middle panel is in the open position.

16. The multiple-panel folding truck bed cover of claim 15, wherein the spacer bracket has a width extending between the front bracket and the rear bracket that is selected to provide a clearance space between a top surface of the front panel and a top surface of the middle panel sufficient to store a rear panel of the multiple-panel folding the truck bed cover therebetween when the truck bed cover is in an open position.

17. The multiple-panel folding truck bed cover of claim 1, comprising two of the compound hinges.

18. The multiple-panel folding truck bed cover of claim 1, further comprising a rear panel pivotally mounted on the middle panel by at least one rear hinge.

19. The multiple-panel folding truck bed cover of claim 18, wherein a top surface of the rear panel folds onto a top surface of the middle panel when the truck bed cover is in a partially open position, and both the rear panel and the middle panel fold onto a top surface of the front panel when the truck bed cover is in a fully open position.

20. The multiple-panel folding truck bed cover of claim 19, comprising two of the compound hinges, wherein each compound hinge comprises:
a front bracket attached to the top surface of the front panel;
a rear bracket attached to the top surface of the middle panel; and
a spacer bracket pivotally connected to the front bracket and the rear bracket having a width extending between the front bracket and the rear bracket that is selected to provide a clearance space between the top surface of the front panel and the top surface of the middle panel sufficient to store the rear panel therebetween when the truck bed cover is in the fully open position.

21. A multiple-panel folding truck bed cover comprising:
a front panel structured and arranged for mounting on truck sidewall rails comprising a front panel rear edge;
a middle panel structured and arranged for mounting on the truck sidewall rails comprising a middle panel front edge; and
at least two compound hinges attached to the front panel adjacent the front panel rear edge and attached to the middle panel adjacent the middle panel front edge spaced apart from each other transversely along a seam between the front panel rear edge and the middle panel front edge.

22. The multiple-panel folding truck bed cover of claim 21, wherein each of the compound hinges comprises:
a front bracket attached to the front panel;
a rear bracket attached to the middle panel; and
a spacer bracket pivotally connected to each of the front bracket and the rear bracket.

23. The multiple-panel folding truck bed cover of claim 22, wherein the front bracket is pivotally connected to the spacer bracket by a front pivot pin, and the rear bracket is pivotally connected to the spacer bracket by a rear pivot pin.

24. The multiple-panel folding truck bed cover of claim 22, wherein the front bracket is attached to a top surface of the front panel, and the rear bracket is attached to a top surface of the middle panel.

25. The multiple-panel folding truck bed cover of claim 24, wherein the spacer bracket comprises an underside that contacts a top surface of either the front panel or a top surface of the middle panel when the front panel and the middle panel are in the closed positions, but does not contact the top surfaces of the front and middle panels when the middle panel is in the open position.

26. The multiple-panel folding truck bed cover of claim 25, wherein the spacer bracket has a width extending between the front bracket and the rear bracket that is selected to provide a clearance space between a top surface of the front panel and a top surface of the middle panel sufficient to store a rear panel of the multiple-panel folding the truck bed cover therebetween when the truck bed cover is in an open position.

27. The multiple-panel folding truck bed cover of claim 21, further comprising:
a catch bar and catch bracket assembly structured and arranged to resist relative movement between the front panel rear edge and the middle panel front edge when the front panel and the middle panel are in closed positions on the truck sidewall rails, wherein the catch bar and catch bracket assembly comprises:
a catch bar attached adjacent to one of the front panel rear edge or the middle panel front edge; and
at least one catch bracket attached adjacent to the other one of the front panel rear edge or the middle panel front edge structured and arranged to engage the catch bar to thereby resist the relative movement between the front panel rear edge and the middle panel front edge when the front panel and the middle panel are in the closed positions.

28. The multiple-panel folding truck bed cover of claim 27, wherein the catch bar is attached to the front panel rear edge, the at least one catch bracket is attached adjacent to the middle panel front edge, the catch bar comprises a catch lip engageable with the at least one catch bracket, and the catch lip forms a water diverting channel vertically below the front panel rear edge and middle panel front edge.

29. The multiple-panel folding truck bed cover of claim 28, wherein the front panel rear edge and the middle panel front edge comprise opposing gasket seals structured and arranged to contact each other when the middle panel is in its closed position to resist water flow between the front panel rear edge and the middle panel front edge.

30. The multiple-panel folding truck bed cover of claim 27, wherein the at least one catch bracket comprises a base attached to an underside of the middle panel, and a latch tab extending from the base structured and arranged to engage the catch bar.

31. The multiple-panel folding truck bed cover of claim 30, wherein the catch bracket is attached to the middle panel by at least one mechanical fastener, and the at least one mechanical fastener also attaches one of the compound hinges to the middle panel.
